(19) United States
(12) Patent Application Publication
(10) Pub. No.: US 2017/0334121 A1
(43) Pub. Date: Nov. 23, 2017

(54) METHOD FOR MAKING A HARD LUGGAGE CASE

(71) Applicant: WEI-HUNG LAI, Taichung City (TW)

(72) Inventor: WEI-HUNG LAI, Taichung City (TW)

(21) Appl. No.: 15/157,377

(22) Filed: May 17, 2016

(51) Int. Cl. B29C 49/06; B29B 11/10; B29B 11/08; B29C 69/00; B29C 49/04; B29L 31/00; B29K 67/00

(52) U.S. Cl. CPC B29C 49/06; B29C 69/001; B29B 11/10; B29C 49/04; B29B 11/08; B29K 2023/06; B29K 2067/003; B29L 2031/7162

(57) ABSTRACT

A method for making a hard luggage case includes: a step of parison forming: including forming a parison; a step of blow molding including: forming the hard luggage case by subjecting the parison to a blow molding process, wherein the hard luggage case includes a cutting line to divide the hard luggage case into a first shell and a second shell; and a step of cutting including: cutting the hard luggage case along the cutting line to separate the first and second shells from each other. The step of blow molding is capable of reducing the manufacturing cost, while improving the life and marketing competiveness of the hard luggage case.

### BACKGROUND

### Field of the Invention

The present invention relates to a method for making a luggage case, and more particularly to a method for making a hard luggage case.

### Related Prior Art

As shown in FIG. 1, a conventional hard luggage case 10 is essentially made by injection molding of ABS (Acrylonitrile butadiene styrene) material, and includes a first shell 11 and a second shell 12 which have one side connected together by a hinge (not shown), and have another side coupled by a zipper 13.

However, the hard luggage case 10 is made of plastic injection molding, and the first and second shells 11, 12 have different configurations. Therefore, the forming of the hard luggage case 10 requires the use of two different moulds, which consequently will increase the manufacturing cost.

In addition, the hard luggage case 10 made of plastic injection molding has a poor performance against various environment reactions, such as tensile, impact and bending, which will cause non-uniform stress distribution, and consequently affects the life of the hard luggage case 10.

Finally, since the hard luggage case 10 is made of plastic injection molding, and in consideration of the factor of mold release, the configuration of the hard luggage case 10 cannot be very complex, which will affect the marketing competiveness of the hard luggage case 10.

The present invention has arisen to mitigate and/or obviate the afore-described disadvantages.

### SUMMARY

The present invention is aimed at providing a method for making a hard luggage case which is essentially made by blow molding, which is capable of reducing the manufacturing cost, while improving the life and marketing competiveness of the hard luggage case.

Therefore, a method for making a hard luggage case in accordance with the present invention comprises:

a step of parison forming including forming a parison;

a step of blow molding including: forming the hard luggage case by subjecting the parison to a blow molding process, wherein the hard luggage case includes a cutting line to divide the hard luggage case into a first shell and a second shell; and

a step of cutting including: cutting the hard luggage case along the cutting line to separate the first and second shells from each other.

Preferably, the parison is made by plastic extrusion.

Preferably, the parison is made by plastic injection molding.

Preferably, the parison is made of Polyethylene Terephthalate.

Preferably, the parison is made of polyethylene.

Preferably, the step of blow molding includes: putting the parison into a blow mold which has a blow cavity, blowing the parison to make the parison inflate and abut against the inner surface of the blow cavity, and demolding to obtain the hard luggage case.

Preferably, the second shell includes a bottom for mounting of wheels.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a perspective view of a conventional hard luggage case;

FIG. 2 is a flow chart of a method for making a hard luggage case in accordance with the preferred embodiment of the present invention;

FIG. 3 is a side view of a parison obtained from the step of parison forming of the method for making a hard luggage case in accordance with the preferred embodiment of the present invention;

FIG. 4 is a cross sectional view showing a state prior to mold closing during the step of blow molding of the method for making a hard luggage case in accordance with the preferred embodiment of the present invention;

FIG. 5 is a cross sectional view showing a state after mold closing during the step of blow molding of the method for making a hard luggage case in accordance with the preferred embodiment of the present invention;

FIG. 6 is a cross sectional view showing a state after blowing process during the step of blow molding of the method for making a hard luggage case in accordance with the preferred embodiment of the present invention;

FIG. 7 is a cross sectional view showing a state after mold opening during the step of blow molding of the method for making a hard luggage case in accordance with the preferred embodiment of the present invention;

FIG. 8 is a cross sectional view showing the step of cutting of the method for making a hard luggage case in accordance with the preferred embodiment of the present invention;

FIG. 9 shows that the wheels are provided on the bottom of the hard luggage case in accordance with the preferred embodiment of the present invention;

FIG. 10 illustrates an embodiment of the cutting line of the present invention; and

FIG. 11 illustrates another embodiment of the cutting line of the present invention.

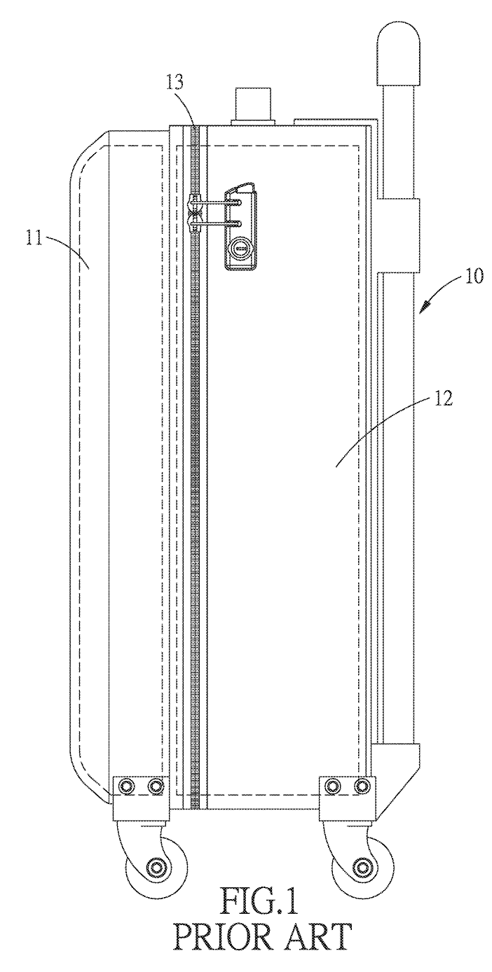

### DETAILED DESCRIPTION

The present invention will be clearer from the following description when viewed together with the accompanying drawings, which show, for purpose of illustrations only, the preferred embodiment in accordance with the present invention.

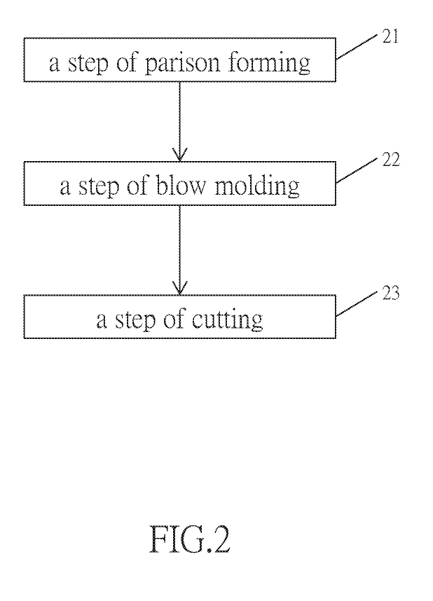

Referring to FIG. 2, a method for making a hard luggage case in accordance with the preferred embodiment of the present invention, comprises the following steps: a step 21 of parison forming, a step 22 of blow molding, and a step 23 of cutting.

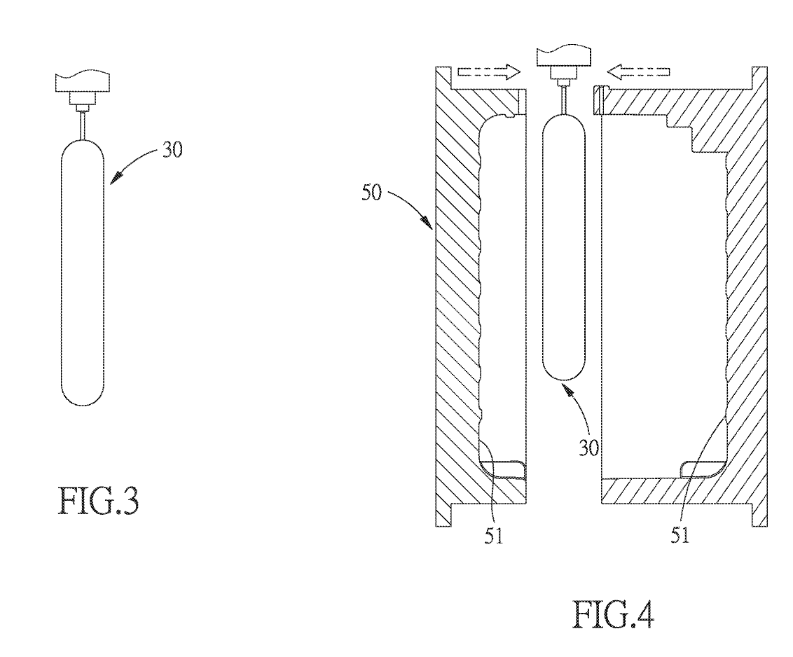

The step 21 of parison forming, as shown in FIG. 3, includes forming a parison 30. In this embodiment, the forming of the parison 30 includes, but not limited to, plastic extrusion, and plastic injection molding. The material of the parison 30 includes, but not limited to, Polyethylene Terephthalate, or polyethylene.

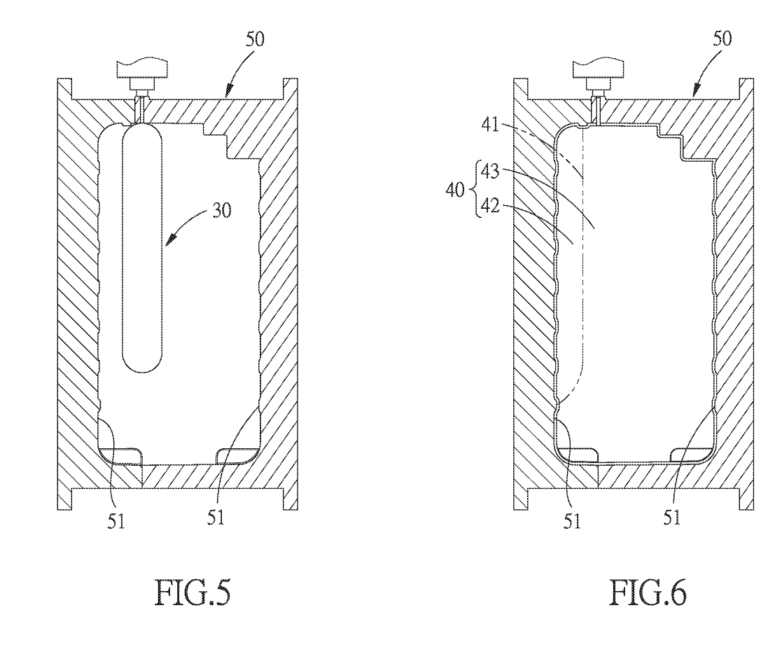

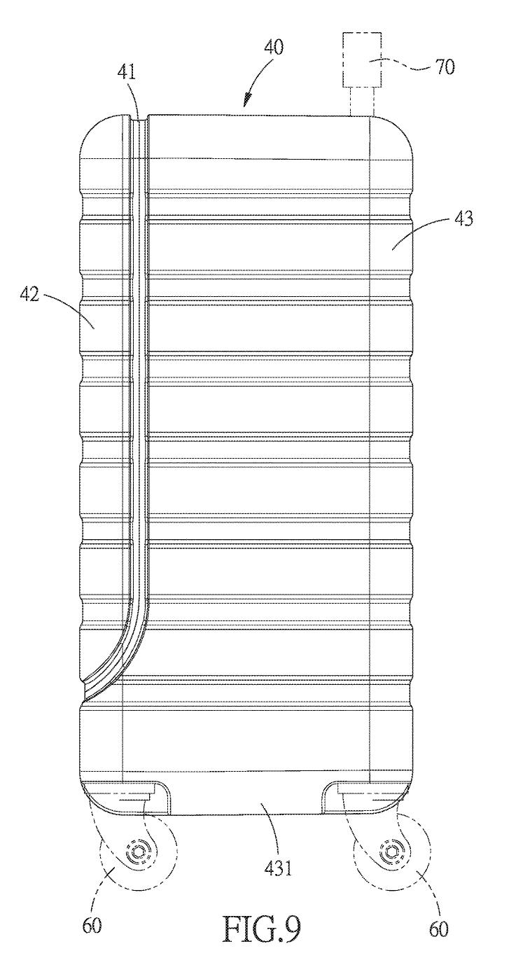

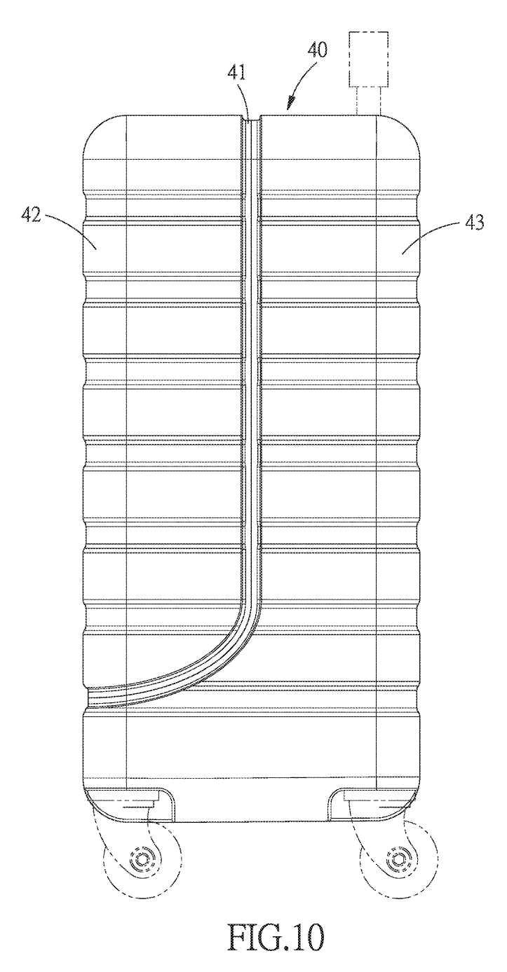

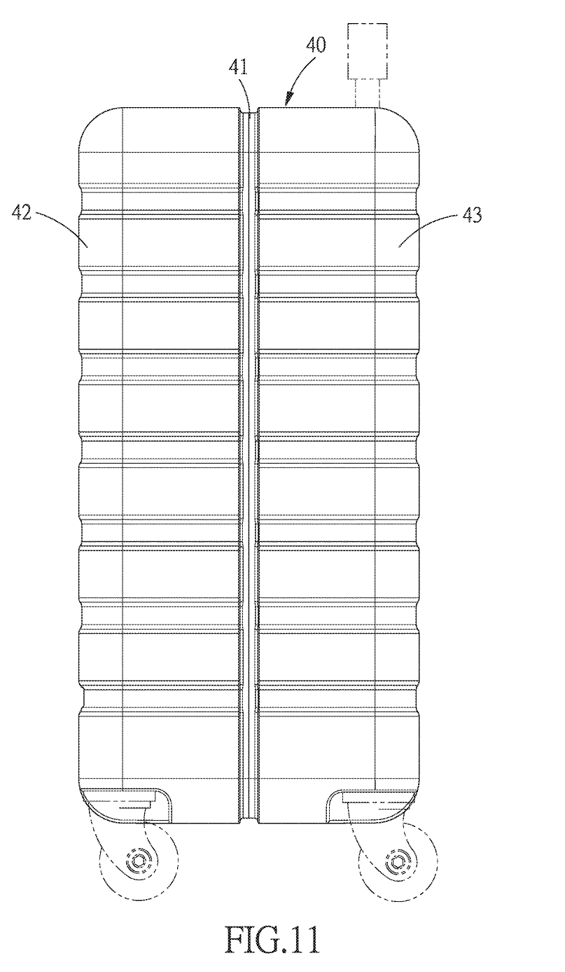

The step 22 of blow molding, as shown in FIGS. 4-7, includes: forming a hollow hard luggage case 40 by subjecting the parison 30 to a blow molding process. The hard luggage case 40 includes a cutting line 41 to divide the hard luggage case 40 into a first shell 42 and a second shell 43. In this embodiment, the step 22 of blow molding includes: putting the parison 30 into a blow mold 50 which has a blow cavity 51, then blowing the parison 30 to make it inflate and abut against the inner surface of the blow cavity 51, and then demolding to obtain the hollow hard luggage case 40. FIG. 9 shows the hollow hard luggage case 40 obtained from the step 22 of blow molding, wherein the second shell 43 includes a bottom 431 for mounting of wheels 60. In other words, the wheels 60 are mounted only on the integrally formed bottom 431 of the second shell 43, but not on the first shell 42, which makes the assembling of the assembling of the wheels 60 an easy operation. The second shell 43 is also provided for mounting of a handle unit 70. Besides, as shown in FIG. 10, the cutting line 41 can extend from the top center of the hard luggage case 40 to the lower left of the hard luggage case 40, so that the first and second shells 42, 43 have different shapes. As shown in FIG. 11, the cutting line 41 can also extend from the top center of the hard luggage case 10 to the bottom center of the hard luggage case 10, which makes the first and second shell 42, 43 have equal shapes.

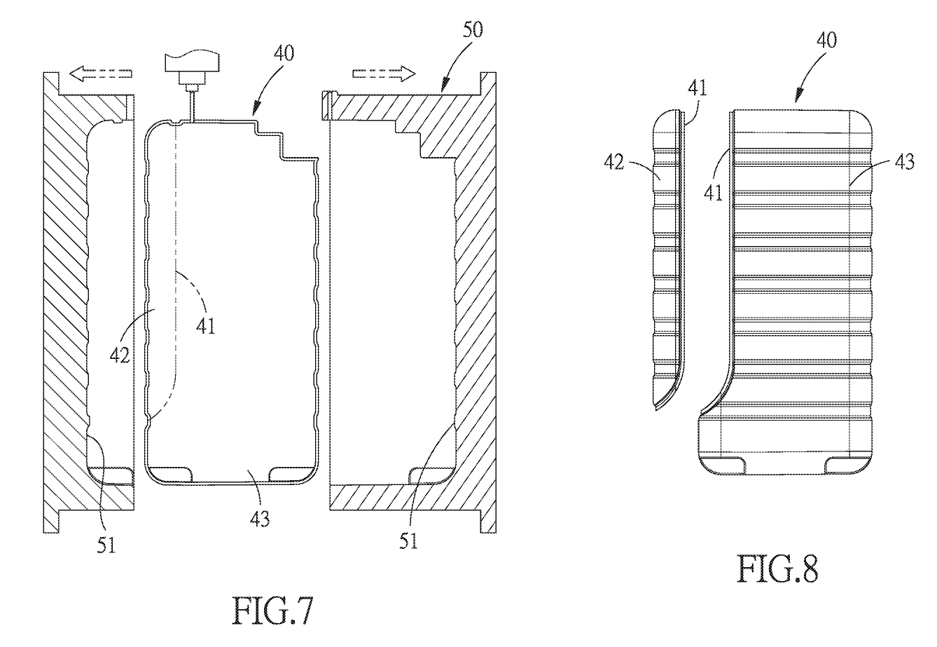

The step 23 of cutting, as shown in FIGS. 7 and 8, includes cutting the hard luggage case 40 along the cutting line 41 to separate the first and second shells 42, 43 from each other.

The method for making the hard luggage case as mentioned above has the following advantages:

1. Since the hard luggage case 40 is made by the steps of: 21 of parison forming, 22 of blow molding, and 23 of cutting, the manufacturing of the hard luggage case 40 only requires the use of a blow mold 50, which consequently reduces the manufacturing cost as compared to the conventional method for making the hard luggage case by plastic injection molding where two molds are required.

2. Since the hard luggage case 40 is made essentially by the step 22 of blow molding, the parison 30 is blown at a relatively low pressure, and the residual stress of the hard luggage case 40 is relatively small, the hard luggage case 40 will have a better performance against various environment reactions, such as tensile, impact and bending, which will cause non-uniform stress distribution, and consequently extends the life of the hard luggage case 40.

3. Since the hard luggage case 40 is made essentially by the step 22 of blow molding, the blow mold 50 is a female mold, demolding will become easy, therefore, the configuration of the hard luggage case 40 can be relatively complex, which will improve the marketing competiveness of the hard luggage case 40.

While we have shown and described various embodiments in accordance with the present invention, it is clear to those skilled in the art that further embodiments may be made without departing from the scope of the present invention.

What is claimed is:

1. A method for making a hard luggage case, comprising:
a step of parison forming: including forming a parison;
a step of blow molding including: forming the hard luggage case by subjecting the parison to a blow molding process, wherein the hard luggage case includes a cutting line to divide the hard luggage case into a first shell and a second shell; and
a step of cutting including: cutting the hard luggage case along the cutting line to separate the first and second shells from each other.

2. The method for making the hard luggage case as claimed in claim 1, wherein the parison is made by plastic extrusion.

3. The method for making the hard luggage case as claimed in claim 1, wherein the parison is made by plastic injection molding.

4. The method for making the hard luggage case as claimed in claim 1, wherein the parison is made of Polyethylene Terephthalate.

5. The method for making the hard luggage case as claimed in claim 1, wherein the parison is made of polyethylene.

6. The method for making the hard luggage case as claimed in claim 1, wherein the step of blow molding includes: putting the parison into a blow mold which has a blow cavity, blowing the parison to make the parison inflate and abut against the inner surface of the blow cavity, and demolding to obtain the hard luggage case.

7. The method for making the hard luggage case as claimed in claim 1, wherein the second shell includes a bottom for mounting of wheels.
